(19) United States
(12) Patent Application Publication
(10) Pub. No.: US 2004/0063412 A1
(43) Pub. Date: Apr. 1, 2004

(54) Attenuation of a received radio frequency signal

(76) Inventors: Hea Joung Kim, El Segundo, CA (US); Brima Ibrahim, Los Angeles, CA (US); Ahmadreza (Reza) Rofougaran, Marina Del Ray, CA (US)

Correspondence Address: Timothy W. Markison, P.O. Box 160727, Austin, TX, 78716-0727, US

(21) Appl. No.: 10/255,391

(22) Filed: Sep. 26, 2002

(51) Int. Cl. H04B 17/00; H04B 1/06; H04B 7/00

(52) U.S. Cl. 455/226.2; 455/250.1

(57) ABSTRACT

Attenuation of received RF signals begins by determining signal strength of the received signal. The processing continues by determining whether the signal strength of the received signal exceeds a high power threshold. The high power threshold is set just below a power level at which the receiver would saturate (e.g., clip the received signals). Processing continues by enabling transmit mode of a transmit/receive switch while receiving the RF signal when the signal strength of the received signal exceeds the high power threshold. With the transmit/receive switch in the transmit mode while receiving an RF signal, the transmit/receive switch provides an attenuation of approximately 20 dBm.

### BACKGROUND OF THE INVENTION

1. Technical Field of the Invention

This invention relates generally to wireless communication systems and more particularly to radio frequency integrated circuits and radio frequency printed circuit boards used in such wireless communication systems.

2. Description of Related Art

Communication systems are known to support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). As is known, the transmitter includes a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

As is also known, the receiver is coupled to the antenna and includes a low noise amplifier, one or more intermediate frequency stages, a filtering stage, and a data recovery stage. The low noise amplifier receives inbound RF signals via the antenna and amplifies then. The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

As is further known, the signal strength of a signal received by a radio receiver decreases approximately exponentially as the distance between the receiver and the transmitter that transmitted the signal increases linearly. As such, most wireless communication standards prescribe a minimum receive signal strength indication (RSSI) and/or signal-to-noise ratio (SNR) at which the receiver must operate, which, along with the prescribed transmit power, effectively establishes the maximum distance between a radio receiver and a radio transmitter. For example, many wireless LAN specifications (e.g., IEEE 802.11a, b, Bluetooth, et cetera) provide a minimum RSSI of −80 dBm with upper power levels of approximately −45 dBm.

As the uses for wireless LANs increase, differing power range requirements are emerging. For instance, wireless LAN applications for computers are requiring a power range of −80 dBm to +4 dBm. Thus, a receiver must be able to accurately process signals over this vast power range. However, since prior applications have a smaller power range that have high power levels of −20 dBm to −45 dBm, most receivers only included gain stages to amplify incoming signals. Thus, even with setting the gain stages at their respective minimum gains, large amplitude signals (e.g., greater than −10 dBm) would saturate the receiver. Once the receiver saturates, its cannot accurately recapture data from received signals.

Therefore, a need exists for a method and apparatus for attenuating received RF signals in radio frequency integrated circuits (RFIC) and/or radio frequency printed circuit boards.

### BRIEF SUMMARY OF THE INVENTION

The attenuation of received RF signals of the present invention substantially meets these needs and others. In one embodiment, a method for attenuating a received RF signal begins by determining signal strength of the received signal. This may be done by utilizing a received signal strength indication module. The processing continues by determining whether the signal strength of the received signal exceeds a high power threshold. The high power threshold is set just below a power level at which the receiver would saturate (e.g., clip the received signals). Processing continues by enabling transmit mode of a transmit/receive switch while receiving the RF signal when the signal strength of the received signal exceeds the high power threshold. With the transmit/receive switch in the transmit mode while receiving an RF signal, the transmit/receive switch provides an attenuation of approximately 20 dBm. As such, high powered signals received by the receiver are attenuated via the transmit/receive switch prior to processing within the receiver thus avoiding saturation of the receiver.

In an alternative embodiment, a method for attenuating a received RF signal begins by determining a 1^{st} signal strength of the received RF signal being received by a 1^{st} antenna. The process continues by determining a 2^{nd} signal strength of the received signal as it is received by a 2^{nd} antenna. The 1^{st} and 2^{nd} antennas are typically located on a printed circuit board and are spaced by approximately ¼ wavelength to one full wavelength apart. As such, when a transmitting device is closer to one antenna than the other, the signal strength will be greater at the antenna to which the transmitter is closest. The processing continues by determining whether the 1^{st} signal strength exceeds a high power threshold and whether the 2^{nd} signal strength is below the high powered threshold. When the 1^{st} signal strength exceeds a high powered threshold and the 2^{nd} signal strength is below the high powered threshold, the processing continues by enabling the radio to receive the RF signal via the 2^{nd} antenna. In this instance, if the use of one antenna would provide too great of an input power and the other would not, the antenna providing the lower input power is used. Accordingly, in any embodiment of the present invention, high powered signals may be received and attenuated such that the receiver portion of a radio frequency integrated circuit will not be saturated.

### BRIEF DESCRIPTION OF THE SEVERAL VIEWS OF THE DRAWINGS

FIG. 1 is a schematic block diagram of a wireless communication system in accordance with the present invention;

FIG. 2 is a schematic block diagram of a wireless communication device in accordance with the present invention;

FIG. 3 is a schematic block diagram of a transmitter portion and receiver portion of the wireless communication device of FIG. 2;

FIG. 4 is a graphical representation of the transmit/receiver switch module in receiver mode in accordance with the present invention;

FIG. 5 is a graphical representation of the transmit/receive switch module in the transmit mode in accordance with the present invention;

FIG. 6 is a logic diagram of a method for attenuating RF signals in accordance with the present invention;

FIG. 7 is a schematic block diagram of multiple antennas coupled to the transmit/receive switch in accordance with the present invention; and

FIG. 8 is a logic diagram of an alternate method for attenuating a received RF signal in accordance with the present invention.

### DETAILED DESCRIPTION OF THE INVENTION

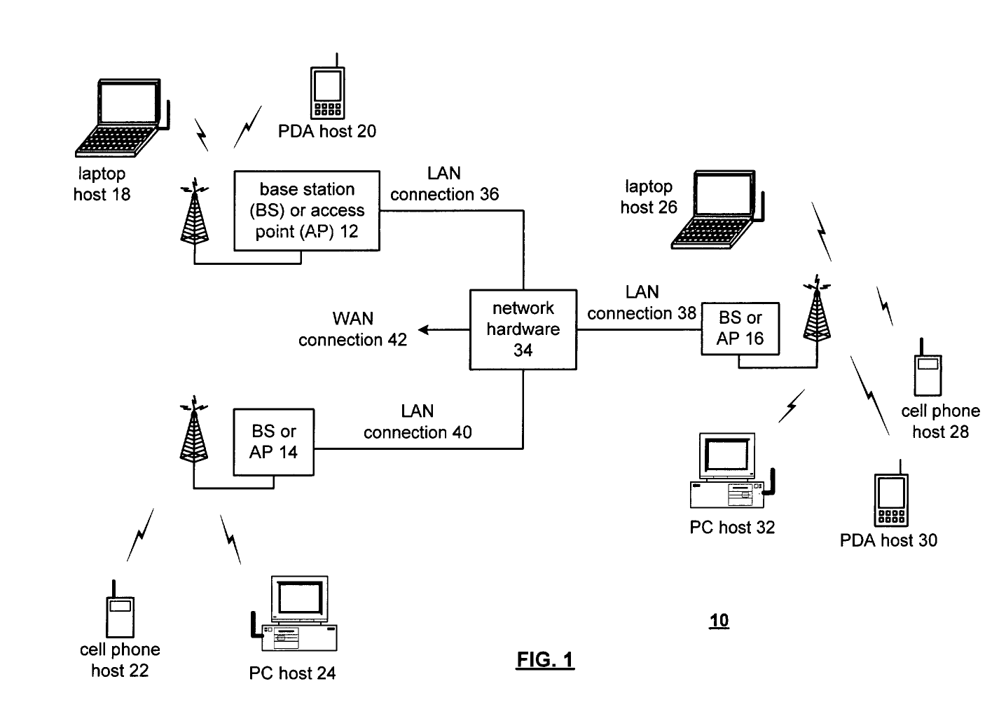

FIG. 1 is a schematic block diagram illustrating a communication system 10 that includes a plurality of base stations and/or access points 12-16, a plurality of wireless communication devices 18-32 and a network hardware component 34. The wireless communication devices 18-32 may be laptop host computers 18 and 26, personal digital assistant hosts 20 and 30, personal computer hosts 24 and 32 and/or cellular telephone hosts 22 and 28. The details of the wireless communication devices will be described in greater detail with reference to FIG. 2.

The base stations or access points 12-16 are operably coupled to the network hardware 34 via local area network connections 36, 38 and 40. The network hardware 34, which may be a router, switch, bridge, modem, system controller, et cetera provides a wide area network connection 42 for the communication system 10. Each of the base stations or access points 12-16 has an associated antenna or antenna array to communicate with the wireless communication devices in its area. Typically, the wireless communication devices register with a particular base station or access point 12-14 to receive services from the communication system 10. For direct connections (i.e., point-to-point communications), wireless communication devices communicate directly via an allocated channel.

Typically, base stations are used for cellular telephone systems and like-type systems, while access points are used for in-home or in-building wireless networks. Regardless of the particular type of communication system, each wireless communication device includes a built-in radio and/or is coupled to a radio. The radio includes a highly linear amplifier and/or programmable multi-stage amplifier as disclosed herein to enhance performance, reduce costs, reduce size, and/or enhance broadband applications.

FIG. 2 is a schematic block diagram illustrating a wireless communication device that includes the host device 18-32 and an associated radio 60. For cellular telephone hosts, the radio 60 is a built-in component. For personal digital assistants hosts, laptop hosts, and/or personal computer hosts, the radio 60 may be built-in or an externally coupled component.

As illustrated, the host device 18-32 includes a processing module 50, memory 52, radio interface 54, input interface 58 and output interface 56. The processing module 50 and memory 52 execute the corresponding instructions that are typically done by the host device. For example, for a cellular telephone host device, the processing module 50 performs the corresponding communication functions in accordance with a particular cellular telephone standard.

The radio interface 54 allows data to be received from and sent to the radio 60. For data received from the radio 60 (e.g., inbound data), the radio interface 54 provides the data to the processing module 50 for further processing and/or routing to the output interface 56. The output interface 56 provides connectivity to an output display device such as a display, monitor, speakers, et cetera such that the received data may be displayed. The radio interface 54 also provides data from the processing module 50 to the radio 60. The processing module 50 may receive the outbound data from an input device such as a keyboard, keypad, microphone, et cetera via the input interface 58 or generate the data itself. For data received via the input interface 58, the processing module 50 may perform a corresponding host function on the data and/or route it to the radio 60 via the radio interface 54.

Radio 60 includes a host interface 62, digital receiver processing module 64, an analog-to-digital converter 66, a filtering/attenuation module 68, an IF mixing down conversion stage 70, a receiver filter 71, a low noise amplifier 72, a transmitter/receiver switch 73, a local oscillation module 74, memory 75, a digital transmitter processing module 76, a digital-to-analog converter 78, a filtering/gain module 80, an IF mixing up conversion stage 82, a power amplifier 84, a transmitter filter module 85, a received signal strength indication (RSSI) module 87, and an antenna 86. The antenna 86 may be a single antenna that is shared by the transmit and receive paths as regulated by the Tx/Rx switch 73, or may include separate antennas for the transmit path and receive path. The antenna implementation will depend on the particular standard to which the wireless communication device is compliant.

The digital receiver processing module 64 and the digital transmitter processing module 76, in combination with operational instructions stored in memory 75, execute digital receiver functions and digital transmitter functions, respectively. The digital receiver functions include, but are not limited to, digital intermediate frequency to baseband conversion, demodulation, constellation demapping, decoding, and/or descrambling. The digital transmitter functions include, but are not limited to, scrambling, encoding, constellation mapping, modulation, and/or digital baseband to IF conversion. The digital receiver and transmitter processing modules 64 and 76 may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 75 may be a single memory device or a plurality of memory devices. Such a memory device may be a read-only memory, random access memory, volatile memory, non-volatile memory, static memory, dynamic memory, flash memory, and/or any device that stores digital information. Note that when the processing module 64 and/or 76 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In operation, the radio 60 receives outbound data 94 from the host device via the host interface 62. The host interface 62 routes the outbound data 94 to the digital transmitter processing module 76, which processes the outbound data 94 in accordance with a particular wireless communication standard (e.g., IEEE 802.11a, IEEE 802.11b, Bluetooth, et cetera) to produce digital transmission formatted data 96. The digital transmission formatted data 96 will be a digital base-band signal or a digital low IF signal, where the low IF typically will be in the frequency range of one hundred kilohertz to a few megahertz.

The digital-to-analog converter 78 converts the digital transmission formatted data 96 from the digital domain to the analog domain. The filtering/gain module 80 filters and/or adjusts the gain of the analog signal prior to providing it to the IF mixing stage 82. The IF mixing stage 82 directly converts the analog baseband or low IF signal into an RF signal based on a transmitter local oscillation 83 provided by local oscillation module 74. The power amplifier 84 amplifies the RF signal to produce outbound RF signal 98, which is filtered by the transmitter filter module 85. The antenna 86 transmits the outbound RF signal 98 to a targeted device such as a base station, an access point and/or another wireless communication device.

The radio 60 also receives an inbound RF signal 88 via the antenna 86, which was transmitted by a base station, an access point, or another wireless communication device. The antenna 86 provides the inbound RF signal 88 to the receiver filter module 71 via the Tx/Rx switch 73, where the Rx filter 71 bandpass filters the inbound RF signal 88. The Rx filter 71 provides the filtered RF signal to low noise amplifier 72, which amplifies the signal 88 to produce an amplified inbound RF signal. The low noise amplifier 72 provides the amplified inbound RF signal to the IF mixing module 70, which directly converts the amplified inbound RF signal into an inbound low IF signal or baseband signal based on a receiver local oscillation 81 provided by local oscillation module 74. The down conversion module 70 provides the inbound low IF signal or baseband signal to the filtering/gain module 68. The filtering/gain module 68 filters and/or gains the inbound low IF signal or the inbound baseband signal to produce a filtered inbound signal. The RSSI module 87 measures the RSSI 91 of the received signal 89, which may be the output of the LNA 72, the output of the down-conversion module 70, the digital reception formatted data 90, the inbound data 92, or intermediaries thereof.

The analog-to-digital converter 66 converts the filtered inbound signal from the analog domain to the digital domain to produce digital reception formatted data 90. The digital receiver processing module 64 decodes, descrambles, demaps, equalizes channel response, and/or demodulates the digital reception formatted data 90 to recapture inbound data 92 in accordance with the particular wireless communication standard being implemented by radio 60. The host interface 62 provides the recaptured inbound data 92 to the host device 18-32 via the radio interface 54.

As one of average skill in the art will appreciate, the wireless communication device of FIG. 2 may be implemented using one or more integrated circuits. For example, the host device may be implemented on one integrated circuit, the digital receiver processing module 64, the digital transmitter processing module 76 and memory 75 may be implemented on a second integrated circuit, and the remaining components of the radio 60, less the antenna 86, may be implemented on a third integrated circuit. As an alternate example, the radio 60 may be implemented on a single integrated circuit. As yet another example, the processing module 50 of the host device and the digital receiver and transmitter processing modules 64 and 76 may be a common processing device implemented on a single integrated circuit. Further, the memory 52 and memory 75 may be implemented on a single integrated circuit and/or on the same integrated circuit as the common processing modules of processing module 50 and the digital receiver and transmitter processing module 64 and 76.

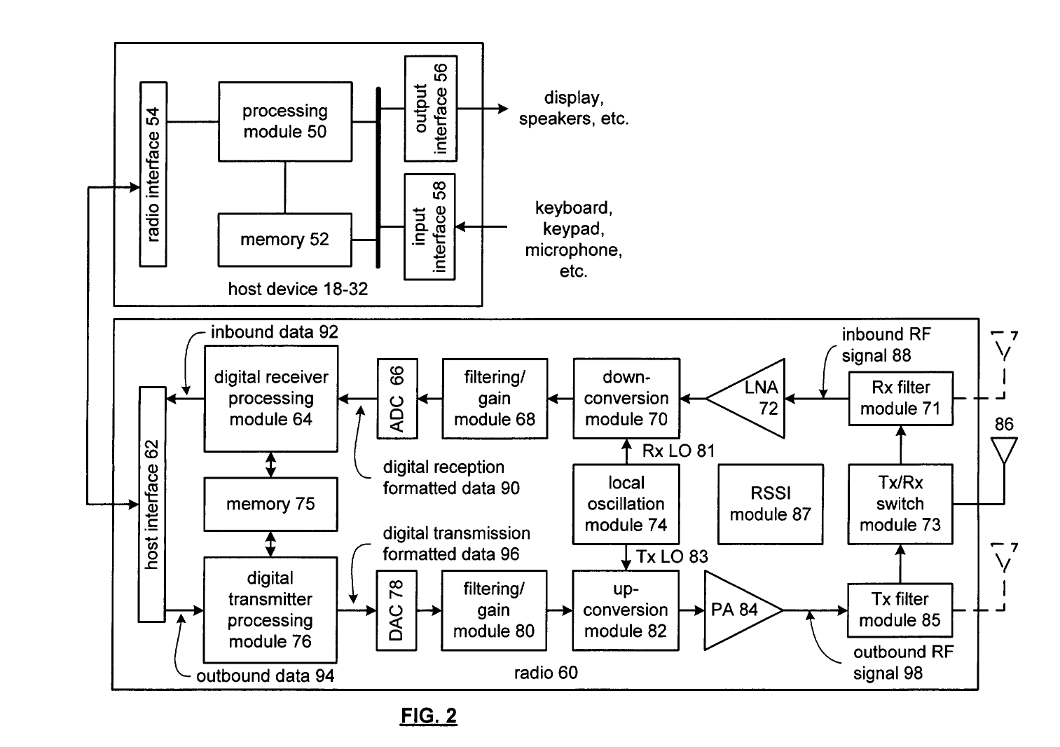

FIG. 3 is a schematic block diagram of a transmitter portion and receiver portion of the radio 60 of FIG. 2. The transmitter portion includes an up-conversion module 82, power amplifier 84 and the transmit filter module 85. The receiver portion includes the receiver filter module 71, the low noise amplifier 72 and the down-conversion module 70. The RSSI module 87 is operably coupled to measure the received signal strength indication 102 from the output of low noise amplifier 72 or from the output of the down-conversion module 70. For a detailed discussion of the RSSI module 87 when determining RSSI 102 from the high frequency signal provided by LNA 72 refer to co-pending patent application entitled “DETERMINATION OF RECEIVED SIGNAL STRENGTH IN A DIRECT CONVERSION RECEIVER”, attorney docket number BP 2339, and a filing date of TBD.

The control module 100, which may be incorporated in the receiver processing module 64 and/or the transmitter processing module 76 provides a select signal 104 to the transmit/receive switch module 73. In normal operation, when the radio is transmitting, the control module 100 places the transmit/receive switch module 73 in the transmit mode. Conversely, when the radio is receiving an RF signal, the control module 100 places the transmit/receive module 73 in the receive mode.

When the RSSI 102 is above a high power threshold (e.g., greater than −10 dBm), the control module 100 generates the select signal 104 to place the transmit/receive switch module 73 in the transmit mode even though the radio is receiving RF signals. By placing the transmit/receive switch module 73 in the transmit mode while receiving a signal, the transmit/receive switch module 73 attenuates the received RF signal prior to filtering by the receive filter module 71.

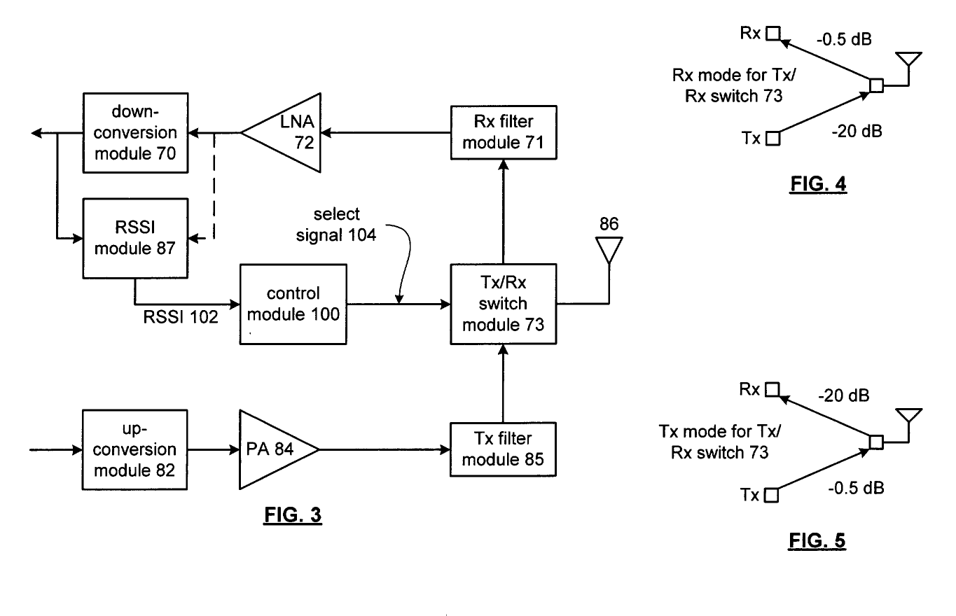

FIGS. 4 and 5 illustrate a graphical representation of the transmit/receive switch 73. In FIG. 4, the transmit/receive switch module 73 is shown in the received mode. In this mode, the path from the antenna to the receiver output has a loss of approximately 0.5 dB. From the antenna to the transmit node, the attenuation is approximately 20 dB. In the transmit mode, the loss between the antenna and the receiver node is 20 dB. The loss from the antenna node to the transmit node in the transmit mode is approximately 0.5 dB. As such, by placing the Tx/Rx switch module 73 in the transmit mode while receiving a signal, the signal is attenuated by approximately 20 dB. As one of average skill in the art will appreciate, the implementation of the transmit/receive switch module 73 determines the actual amount of attenuation when used in the opposite mode. Accordingly, the amount of attenuation may deviate from the −20 dB provided in the examples of FIGS. 4 and 5.

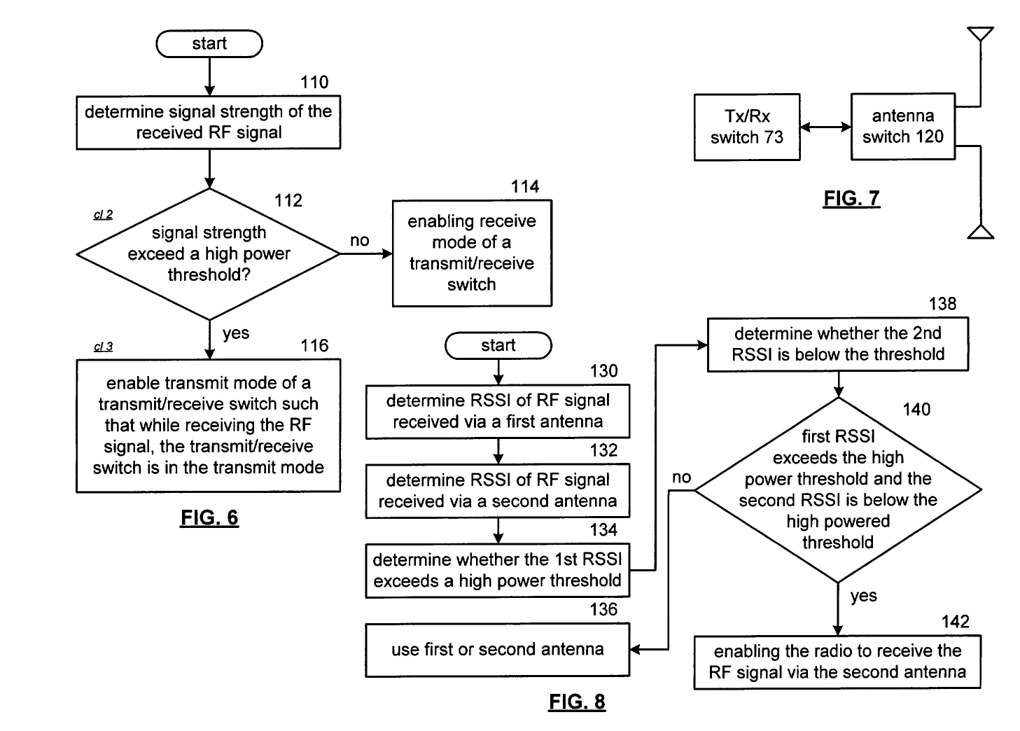

FIG. 6 is a logic diagram of a method for attenuating a radio frequency signal in a radio frequency integrated circuit. The process begins at Step 110 where signal strength of a received RF signal is determined. The process then proceeds to Step 112 where a determination is made as to whether the signal strength exceeds a high power threshold. The high power threshold is established to correspond to a signal strength level just below when the processing of the RF signal, if it were unattenuated, would be clipped, or saturate the receiver portion of the RFIC. If the signal strength does not exceed the high power threshold, the process proceeds to Step 114 where the receiver mode of the transmit/receiver switch is enabled.

If, however, the signal strength of the received signal exceeds the high power threshold, the process proceeds to Step 116. At Step 116, the transmit mode of the transmit/receive switch is enabled such that, while the radio is receiving the RF signal, the transmit/receive switch is in the transmit mode.

FIG. 7 illustrates a schematic block diagram of the transmit/receive switch 73 being coupled to an antenna switch 120. In turn, the antenna switch 120 is coupled to two antennas that are separated by at least ¼ wave length. When a transmitter is in close proximity to the radio receiver that includes the antenna switch 120 of FIG. 7, one antenna is more likely to have a greater receive signal strength than the other. If the antenna having the greater signal strength exceeds a high power threshold, the signal received through the antenna having the lower signal strength can be used thereby achieving a reduction in received signal strength. Note that the antenna switch may be incorporated into the radio frequency integrated circuit, or may be a separate component on a printed circuit board.

FIG. 8 illustrates a logic diagram of a method for attenuating a received RF signal by a radio. The process begins at Step 130 where RSSI of a received RF signal is determined where the signal is received via a 1^{st} antenna. The process then proceeds to Step 132 where RSSI of the RF signal is determined as it is received via a 2^{nd} antenna. The process then proceeds to Step 134 where a determination is made as to whether the RSSI of the signal received via the 1^{st} antenna exceeds a high powered threshold. The process then proceeds to Step 138 where a determination is made as to whether the 2^{nd} received signal strength of the RF signal received via the 2^{nd} antenna is below the high powered threshold. The process then proceeds to Step 140 where a determination is made as to when the 1^{st} RSSI (i.e., RSSI of signal received via the 1^{st} antenna) exceeds the high powered threshold and the 2^{nd} RSSI (i.e., RSSI of signal received via the 2^{nd} antenna) is below the high powered threshold. If not, the process proceeds to Step 136 where either of the 1^{st} or 2^{nd} antennas may be used to receive the incoming RF signal. If, however, the determination at Step 140 is yes, the process proceeds to Step 142 where the radio is enabled to receive the RF signal via the 2^{nd} antenna (i.e., yielding the RSSI below the high powered threshold).

The preceding discussion has presented a method and apparatus for attenuating a received RF signal. Attenuation is sometimes needed when the transmitting radio is in very close proximity to the receiving radio. In this instance, if the RF signal were unattenuated, the receiving radio, while processing the RF signal, would saturate thereby causing errors. As such, by attenuating the received RF signal, saturation of the receiver portion of the receiving radio is avoided. As one of average skill in the art will appreciate, other embodiments may be derived from the teachings of the present invention, without deviating from the scope of the claims.

What is claimed is:

1. A method for a radio to attenuate a received radio frequency (RF) signal, the method comprises:
determining signal strength of the received RF signal;
determining whether the signal strength of the received RF signal exceeds a high power threshold; and
when the signal strength of the received RF signal exceeds the high power threshold, enabling transmit mode of a transmit/receive switch such that while receiving the RF signal the transmit/receive switch is in the transmit mode.

2. The method of claim 1, wherein the determining whether the signal strength exceeds the high power threshold further comprises:
establishing the high power threshold to correspond to a signal strength level just below when processing of the RF signal, if unattenuated, would be clipped.

3. The method of claim 1, wherein the enabling the transmit mode of the transmit/receiver switch further comprises:
generating a transmit select signal; and
providing the transmit select signal to the transmit/receive switch.

4. A method for a radio to attenuate a received radio frequency (RF) signal, the method comprises:
determining a first signal strength of the received RF signal via a first antenna;
determining a second signal strength of the received RF signal via a second antenna;
determining whether the first signal strength exceeds a high power threshold;
determining whether the second signal strength is below the high power threshold; and
when the first signal strength exceeds the high power threshold and the second signal strength is below the high powered threshold, enabling the radio to receive the RF signal via the second antenna.

5. The method of claim 4, wherein the determining whether the first and second signal strengths exceed the high power threshold further comprises:
establishing the high power threshold to correspond to a signal strength level just below when processing of the RF signal, if unattenuated, would be clipped.

6. The method of claim 4 further comprises:
when the first and second signal strengths of the received RF signal exceed the high power threshold, enabling transmit mode of a transmit/receive switch such that while receiving the RF signal, the transmit/receive switch is in the transmit mode.

7. The method of claim 6, wherein the enabling the transmit mode of the transmit/receiver switch further comprises:
generating a transmit select signal; and
providing the transmit select signal to the transmit/receive switch.

8. An integrated radio comprises:
transmitter section operably coupled to convert outbound data into outbound RF signals;
receiver section operably coupled to convert inbound RF signals into inbound data;
at least one antenna;
transmit/receive switch operable to couple the antenna to the transmitter section and the receiver section based on a control signal;
receive signal strength mode operably coupled to determine signal strength of the inbound RF signals; and
control module operably coupled to:
determine whether the signal strength of the inbound RF signals exceeds a high power threshold; and
when the signal strength of the inbound RF signals exceeds the high power threshold, enable transmit mode of a transmit/receive switch to couple the receiver section to the at least one antenna.

9. The integrated radio of claim 8, wherein the control module further functions to:
establish the high power threshold to correspond to a signal strength level just below when processing of the RF signal, if unattenuated, would be clipped.

10. The integrated radio of claim 8, wherein the control module enables the transmit mode of the transmit/receiver switch by:
generating the control signal for the transmit mode; and
providing the control signal to the transmit/receive switch.

11. An integrated radio comprises:
transmitter section operably coupled to convert outbound data into outbound RF signals;
receiver section operably coupled to convert inbound RF signals into inbound data;
a first antenna;
a second antenna
an antenna switch operable to couple the first antenna or the second antenna to the transmitter section and the receiver section based on an antenna select control signal;
receive signal strength mode operably coupled to determine a first signal strength of the inbound RF signals received via the first antenna and to determine a second signal strength of the inbound RF signals received via the second antenna; and
control module operably coupled to:
determine whether the first signal strength exceeds a high power threshold;
determine whether the second signal strength is below the high power threshold; and
when the first signal strength exceeds the high power threshold and the second signal strength is below the high powered threshold, enable the radio to receive the RF signal via the second antenna.

12. The integrated radio of claim 11, wherein the control module further functions to determine whether the first and second signal strengths exceed the high power threshold by:
establishing the high power threshold to correspond to a signal strength level just below when processing of the RF signal, if unattenuated, would be clipped.

13. The integrated radio of claim 11 further comprises:
transmit/receive switch operable to couple the antenna to the transmitter section and the receiver section based on a control signal, wherein, when the first and second signal strengths of the received RF signal exceed the high power threshold, the control module enables transmit mode of a transmit/receive switch such that while receiving the RF signal, the transmit/receive switch is in the transmit mode.

14. The integrated radio of claim 13, wherein the control module further functions to enable the transmit mode of the transmit/receiver switch by:
generating the control signal for transmit mode; and
providing the control signal to the transmit/receive switch.
